(19) United States
(12) Patent Application Publication
(10) Pub. No.: US 2016/0285126 A1
(43) Pub. Date: Sep. 29, 2016

(54) ELECTROLYTE FORMULATIONS FOR GAS SUPPRESSION AND METHODS OF USE

(71) Applicant: Wildcat Discovery Technologies, Inc., San Diego, CA (US)

(72) Inventors: Gang Cheng, San Diego, CA (US); Steven Kaye, San Diego, CA (US)

(21) Appl. No.: 14/671,123

(22) Filed: Mar. 27, 2015

(51) Int. Cl. H01M 10/0567; H01M 4/485; H01M 10/42; H01M 10/052

(52) U.S. Cl. CPC H01M 10/0567; H01M 10/052; H01M 4/485; H01M 10/4235; H01M 2300/0025

(57) ABSTRACT

Combinations of additives for use in electrolyte formulations that provide a number of desirable characteristics when implemented within batteries, such as reduction, suppression, and/or inhibition of undesirable gas generation over several cycles of charging and discharging, in some cases during operation at high temperature and in some cases during high temperature storage.

### BACKGROUND OF THE INVENTION

The present invention is in the field of battery technology and, more particularly, electrolyte formulations that address challenges associated with gas generation in lithium ion batteries.

Gas evolution during storage and use is a major failure mechanism of lithium ion batteries. The mechanism of gas generation is still not well understood. It has been shown that the parasitic reactions between electrolyte and electrodes could result in gaseous products. Gas formed in the cells could cause impedance growth, electrode delamination, swelling, and active material isolation. One or more of these outcomes could lead to faster capacity fade, cell failure, and safety concerns.

Lithium ion batteries operating at higher voltage are in demand to meet the comparatively higher energy density requirement for a variety of applications, including automotive applications. However, challenges in maintaining battery life over high multiples of charge/discharge cycles and safety concerns prevent higher voltage lithium ion batteries from being more widely used. For example, gas generation can in turn lead to swelling and/or deformation of the battery. In pouch type batteries (batteries with soft shells), this deformation can lead to rupture. Thus, gas generation can lead to capacity fade, power fade, and safety risks in lithium ion batteries.

Gas evolution tends to be more significant at higher operating voltages for one or more of the following reasons: (i) oxidative decomposition of solvent components, such as carbonates, leading to formation of CO₂ or gaseous organic compounds; (ii) unstable cathodes at high delithiation states leading to oxygen evolution, which could cause further electrolyte decomposition; (iii) formation of acidic product from salt decomposition resulting in decomposition and reformation of the solid-electrolyte interface (SEI), which can cause rapid capacity fade and gas evolution.

Gas generation can also occur during high temperature storage of lithium ion batteries, which limits the applications in which certain lithium ion batteries can be used.

Prior efforts to reduce gas generation in lithium ion cells have focused mainly on using electrolyte additives and various approaches to electrode coating. To date, these efforts have not been successful in addressing gas evolution.

These and other challenges can be addressed by certain embodiments of the invention described herein.

### BRIEF SUMMARY OF THE INVENTION

Embodiments of the present invention are electrolyte formulations including a combination of additives. One additive is a silicon containing additive and one additive is a film forming heterocycle additive. Examples of silicon containing additives include organic molecules having a silicon moiety, such as tris(trimethylsilyl) phosphate. Examples of film forming additives include organic molecules that include a heterocycle, such as 1,3-propane sultone, maleic anhydride, and maleic imide.

Embodiments of the present invention include the methods of making such electrolyte formulations using the combination of additives disclosed herein, the methods of forming batteries including such electrolyte formulations having the combination of additives disclosed herein, and using batteries including such electrolyte formulations having the additives disclosed herein.

### BRIEF DESCRIPTION OF SEVERAL VIEWS OF THE DRAWINGS

FIG. 1 illustrates the electrochemical performance of various electrolyte formulations, including some formulations made according to certain embodiments of the invention.

FIG. 2 illustrates the results of gas generation testing of the various electrolyte formulations from FIG. 1.

FIGS. 3A, 3B, and 3C illustrate the time-dependence of the gas evolution in battery cells formed with certain electrolyte formulations.

### DETAILED DESCRIPTION OF THE INVENTION

The following definitions apply to some of the aspects described with respect to some embodiments of the invention. These definitions may likewise be expanded upon herein. Each term is further explained and exemplified throughout the description, figures, and examples. Any interpretation of the terms in this description should take into account the full description, figures, and examples presented herein.

The singular terms “a,” “an,” and “the” include the plural unless the context clearly dictates otherwise. Thus, for example, reference to an object can include multiple objects unless the context clearly dictates otherwise.

The terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

The term “about” refers to the range of values approximately near the given value in order to account for typical tolerance levels, measurement precision, or other variability of the embodiments described herein.

A rate “C” refers to either (depending on context) the discharge current as a fraction or multiple relative to a “1 C” current value under which a battery (in a substantially fully charged state) would substantially fully discharge in one hour, or the charge current as a fraction or multiple relative to a “1 C” current value under which the battery (in a substantially fully discharged state) would substantially fully charge in one hour.

Ranges presented herein are inclusive of their endpoints. Thus, for example, the range 1 to 3 includes the values 1 and 3 as well as the intermediate values.

The electrolyte solutions having combinations of additives described herein can be used for a variety of batteries containing a high voltage cathode or a low voltage cathode, and in particular in batteries operated at high temperatures and in batteries stored at high temperatures. For example, the electrolyte solutions having combinations of additives described herein can be substituted in place of conventional electrolytes for lithium ion batteries for operations at or below 4.2 V (low voltage) or at or above 4.2 V (high voltage).

A lithium ion battery formed in accordance with embodiments of the invention includes an anode, a cathode, and a separator that is disposed between the anode and the cathode. The battery also includes an electrolyte formulation, which is disposed between the anode and the cathode and provides improved performance during high voltage battery cycling and/or low voltage battery cycling in high temperature environments or during high temperature storage.

The operation of the battery is based upon reversible intercalation and de-intercalation of lithium ions into and from the host materials of the anode and the cathode. Other implementations of the battery are contemplated, such as those based on conversion chemistry. The voltage of the battery is based on redox potentials of the anode and the cathode, where lithium ions are accommodated or released at a lower potential in the anode and a higher potential in the cathode. Certain embodiments of the electrolyte formulation disclosed herein are suitable for use with both conventional cathode materials and with high voltage cathode materials.

To allow both a higher energy density and a higher voltage platform to deliver that energy, the cathode can include an active cathode material for high voltage operations at or above 4.2 V. Suitable high voltage cathode materials include those capable of stable operation up to about 6.0 V, up about 5.5 V, up to about 5.0 V, and up to about 4.5 V relative to a lithium metal anode (Li/Li⁺ anode) or other counter electrode.

Examples of suitable high voltage cathode materials include phosphates, fluorophosphates, fluorosulfates, fluorosilicates, spinels, lithium-rich layered oxides, and composite layered oxides. Further examples of suitable cathode materials include: spinel structure lithium metal oxides, layered structure lithium metal oxides, lithium-rich layered structured lithium metal oxides, lithium metal silicates, lithium metal phosphates, metal fluorides, metal oxides, sulfur, and metal sulfides.

For example, a class of suitable high voltage spinels can be represented as: Liₐ(M1_{b}M2_{c}M3_{d}M4ₑ)_{f}O₄, where M1, M2, M3, and M4 can be the same or different, M1 is Mn or Fe, M2 is Mn, Ni, Fe, Co, or Cu, M3 is a transition metal, such as Ti, V, Cr, Mn, Fe, Co, Ni, Zr, Nb, or Mo, and M4 is a transition metal or a main group element, optionally excluding elements of Group VIA and Group VIIA, 1.2≧a≧0.9 (or 1.2>a>0.9), 1.7≧b≧1.2 (or 1.7>b>1.2), 0.8≧c≧0.3 (or 0.8>c>0.3), 0.1≧d≧0 (or 0.1>d>0), 0.1≧e≧0 (or 0.1>e>0), and 2.2≧f≧1.5 (or 2.2>f>1.5). LMNO-type cathode materials, such as Li_{1.05}Mn_{0.5}Ni_{0.5}O₄ and LMO-type materials, such as LiMn₂O₄ are included in this class.

For example, a class of suitable high voltage, lithium-rich layered oxides can be represented as: Li(LiₐM1_{b}M2_{c}M3_{d}M4ₑ)_{f}O₂, where M1, M2, M3, and M4 can be the same or different, M1 is a transition metal, such as Mn, Fe, V, Co, or Ni, M2 is a transition metal, such as Mn, Fe, V, Co, or Ni, M3 is a transition metal, such as Mn, Fe, V, Co, or Ni, M4 is a transition metal or a main group element, optionally excluding elements of Group VIA and Group VIIA, 0.4≧a≧0.05 (or 0.4>a>0.05), 0.7≧b≧0.1 (or 0.7>b>0.1), 0.7≧c≧0.1 (or 0.7>c>0.1), 0.7≧d≧0.1 (or 0.7>d>0.1), 0.2≧e≧0 (or 0.2>e>0), and 1.2≧f≧0.9 (or 1.2>f>0.9). The term “OLO” refers to an over-lithiated oxide material and such cathode materials are included in this class.

For example, a class of suitable high voltage, composite layered oxides can be represented as: (Li₂M1ₐM2_{b}O₃)_{c} (LiM3_{d}M4ₑM5_{f}O₂)_{g}, where M1, M2, M3, M4, and M5 can be the same or different, M1 is a transition metal, such as Mn, Fe, V, Co, or Ni, M2 is a transition metal, such as Mn, Fe, V, Co, or Ni, M3 is a transition metal, such as Mn, Fe, V, Co, or Ni, M4 is a transition metal, such as Mn, Fe, V, Co, or Ni, M5 is a transition metal or a main group element, optionally excluding elements of Group VIA and Group VIIA, 1.1≧a≧0 (or 1.1>a>0), 0.5≧b≧0 (or 0.5>b>0), 0.7≧c≧0 (or 0.7>c>0), 1≧d≧0 (or 1>d>0), 1≧e≧0 (or 1>e>0), 1≧f≧0 (or 1>f>0), and 1≧g≧0.5 (or 1>g>0.5).

Examples of suitable anode materials include conventional anode materials used in lithium ion batteries, such as lithium, graphite (LiₓC₆), and other carbon, silicon, or oxide-based anode materials.

Examples of suitable solvents include nonaqueous electrolyte solvents for use in lithium ion batteries, including carbonates, such as ethylene carbonate, dimethyl carbonate, ethyl methyl carbonate, propylene carbonate, methyl propyl carbonate, and diethyl carbonate; sulfones; silanes; nitriles; esters; ethers; and combinations thereof.

Examples of suitable salts include lithium containing salts for use in lithium ion batteries, such as lithium hexafluorophosphate (LiPF₆), lithium perchlorate (LiClO₄), lithium tetrafluoroborate (LiBF₄), lithium trifluoromethane sulfonate (LiCF₃SO₃), lithium bis(trifluoromethane sulfonyl) imide (LiN(CF₃SO₂)₂), lithium bis(perfluoroethyl sulfonyl) imide (LiN(CF₃CF₂SO₂)₂), lithium bis(oxalato)borate (LiB(C₂O₄)₂), lithium difluoro oxalato borate (LiF₂BC₂O₄), and combinations thereof.

Other suitable solvents and salts can be used to yield electrolyte formulations having low electronic conductivity, high lithium ion solubility, low viscosity, and other desirable characteristics. The combination additives disclosed herein can be used as additives in the various electrolyte formulations possible via the combination of salts and solvents disclosed herein.

The electrolyte formulations disclosed herein can be prepared using a variety of techniques, such as by mixing the base electrolyte and the combinations of additives, dispersing the combinations of additives within the base electrolyte, dissolving the combinations of additives within the base electrolyte, or otherwise placing these components in contact with one another. The combinations of additives can be provided in a liquid form, a powdered form (or another solid form), or a combination thereof. The combinations of additives can be incorporated in the electrolyte solutions prior to, during, or subsequent to battery assembly.

When an electrolyte includes a base conventional electrolyte, during initial battery cycling components within the base electrolyte can assist in the in-situ formation of a protective film (in the form of a solid-electrolyte interface (SEI)) on or next to the anode. The anode SEI can decrease or inhibit reductive decomposition of the conventional electrolyte. Preferably, and without being bound by theory not recited in the claims, the electrolyte formulations having the combinations of additives disclosed herein can assist in the in-situ formation of a protective film (in the form of a SEI) on or next to a cathode. The cathode SEI can inhibit oxidative decomposition of the electrolyte. Further, the electrolyte formulations having the combinations of additives disclosed herein can assist in the formation of more stable anode SEI. Together, the anode SEI and the cathode SEI formed by the electrode formulations disclosed herein can reduce gas generation in lithium ion batteries.

Electrolyte formulations including the combinations of electrolyte additives disclosed herein can form comparatively robust SEI films on cathode surfaces. Certain of the electrolyte formulations can inhibit or prevent the decomposition of lithium salts (including, but not limited to, LiPF₆). The robust SEI films and stable lithium salts can mitigate gas generation in batteries containing these electrolyte formulations.

Certain electrolyte formulations disclosed herein include a silicon-containing compound as one of the additives in the additive combination. Certain silicon-containing additives can reduce oxidative decomposition of conventional electrolytes by promoting SEI formation on the battery cathode. For example, US Patent Publication US20120315536, the entire content of which is incorporated by reference herein, discloses a variety of silicon containing additives that promote SEI formation on the battery cathode. These compounds are believed to form a protective layer at the cathode surface and the resulting SEI could mitigate oxidative decomposition of the electrolyte solvent.

Examples of compounds that can promote SEI formation on the battery cathode include, but are not limited to, compounds of formula (I):

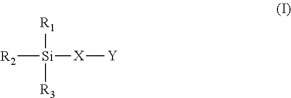

where R₁, R₂, and R₃ are independently selected from the group consisting of substituted and unsubstituted C₁-C₂₀ alkyl groups, substituted and unsubstituted C₁-C₂₀ alkenyl groups, substituted and unsubstituted C₁-C₂₀ alkynyl groups, and substituted and unsubstituted C₅-C₂₀ aryl groups; X is nitrogen or oxygen; and Y is selected from the group consisting of hydride groups, halo groups, hydroxy groups, thio groups, alkyl groups, alkenyl groups, alkynyl groups, aryl groups, iminyl groups, alkoxy groups, alkenoxy groups, alkynoxy groups, aryloxy groups, carboxy groups, alkylcarbonyloxy groups, alkenylcarbonyloxy groups, alkynylcarbonyloxy groups, arylcarbonyloxy groups, alkylthio groups, alkenylthio groups, alkynylthio groups, arylthio groups, cyano groups, N-substituted amino groups, alkylcarbonylamino groups, N-substituted alkylcarbonylamino groups, alkenylcarbonylamino groups, N-substituted alkenyl carbonylamino groups, alkynylcarbonyl amino groups, N-substituted alkynylcarbonylamino groups, arylcarbonylamino groups, and N-substituted arylcarbonylamino groups, boron-containing groups, aluminum-containing groups, silicon-containing groups, phosphorus-containing groups, and sulfur-containing groups. However, certain of these silicon-containing additives alone were found to not substantially suppress gas generation in testing conducted as described below.

Certain electrolyte formulations disclosed herein include a film forming compound as one of the additives in the additive combination. Certain film-forming additives have been shown to form a protective layer on carbon based anodes, and the protective layer can inhibit reductive decomposition in of the electrolyte. When operating at high voltages (such as voltages above about 4.5 V vs. a lithium based cathode), the performance of the film forming additives can be significantly compromised. At high voltages, the film forming additives can be readily oxidized prior to formation of a stable SEI on the carbon based anode.

Film forming additives include, but are not limited to, comparatively small molecules that can react with each other and/or with the electrode surface to form a comparatively robust and stable film. Structurally, film forming additives include monomer-type molecules that have unsaturated carbon bonds. The molecules can be linear or cyclic. Cyclic compounds can be heterocycles, have multiple rings, and include highly strained rings such as 3-, 4-, 5-, and 6-membered rings and spirocyclic structures). Particularly, heterocyclic film forming additives are highly reactive towards nucleophilic species or radical anions to form homogenous and protective films. As with the silicon containing additives, these SEI-forming additives did not substantially suppress gas generation. Preferred film forming additives include 1,3-propane sultone:

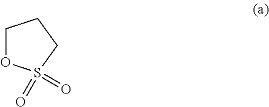

maleic anhydride:

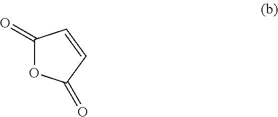

and maleic imide

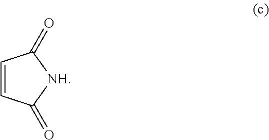

The preferred film forming additives are all cyclic molecules with one or more heteroatom. In addition, these heterocycles all contain highly strained 5-membered ring. Thus, one class of preferred film forming additives is small membered ring heterocycles.

Surprisingly, the combination of silicon containing additives and SEI-forming additives achieved an unexpectedly high degree of gas suppression. As demonstrated herein, certain additive combinations suppressed gas generation in batteries in a number of challenging environments including high temperature storage of the battery in a charged state. The charged state can be fully charged or partially charged and the benefits of the additive combinations can still be realized. Further, certain electrolyte formulations disclosed herein can suppress gas generation during high temperature storage of a battery held at 4.9 V without substantial negative effects on the initial reversible capacity of the battery. This result demonstrates unexpected synergy between the two types of additives and improves high voltage and high temperature stability in lithium ion batteries.

In certain embodiments of the invention, the additive is present at an amount that is significantly lower than the amount of electrolyte salt present in the electrolyte formulation of the electrochemical cell. The amount of additive can be expressed as a weight percent (wt %) of the total weight of the electrolyte formulation. In certain embodiments of the invention, the concentration of additive in the electronic formulation is less than or equal to about 5 weight percent, more preferably less than or equal to about 4 weight percent, more preferably less than or equal to about 3 weight percent, and still more preferably less than or equal to about 2 weight percent.

In certain embodiments of the invention, the concentration of each additive in the electronic formulation is equal to about 4.0 wt %, 3.9 wt %, 3.8 wt %, 3.7 wt %, 3.6 wt %, 3.5 wt %, 3.4 wt %, 3.3 wt %, 3.2 wt %, 3.1 wt %, 3.0 wt %, 2.9 wt %, 2.8 wt %, 2.7 wt %, 2.6 wt %, 2.5 wt %, 2.4 wt %, 2.3 wt %, 2.2 wt %, or 2.1 wt %, 2.0 wt %, 1.9 wt %, 1.8 wt %, 1.7 wt %, 1.6 wt %, 1.5 wt %, 1.4 wt %, 1.3 wt %, 1.2 wt %, 1.1 wt %, 1.0 wt %, 0.9 wt %, 0.8 wt %, 0.7 wt %, 0.6 wt %, 0.5 wt %, 0.4 wt %, 0.3 wt %, 0.2 wt %, or 0.1 wt %. In certain embodiments of the invention, the concentration of additive in the electrolyte formulation is in the range of about 2.0 wt % to about 0.5 wt %.

Advantageously, the electrolyte formulations including the combinations of additives disclosed herein can reduce, suppress, or inhibit gas generation over a wide range of operational temperatures, such as when batteries incorporating the electrolyte formulations including certain combinations of additives disclosed herein are charged, discharged, or cycled from about −40° C. to about 80° C., from about −40° C. to about 60° C., from about −40° C. to about 25° C., from about −40° C. to about 0° C., from about 0° C. to about 60° C., from about 0° C. to about 25° C., from about 25° C. to about 60° C., or other ranges encompassing temperatures greater than or below 25° C. The inventive electrolyte formulations also can provide these performance characteristics over a wide range of operational voltages between a rated cut-off voltage and a rated charge voltage, such as when the batteries are charged, discharged, or cycled between voltage ranges encompassing about 2 V to about 4.2 V, about 2 V to about 4.3 V, about 2 V to about 4.5 V, about 2 V to about 4.6 V, about 2 V to about 4.7 V, about 2 V to about 4.95 V, about 3 V to about 4.2 V, about 3 V to about 4.3 V, about 3 V to about 4.5 V, about 3 V to about 4.6 V, about 3 V to about 4.7 V, about 3 V to about 4.9 V, about 2 V to about 6 V, about 3 V to about 6 V, about 4.2 V to about 6 V, about 4.5 V to about 6 V, about 2 V to about 5.5 V, about 3 V to about 5.5 V, about 4.5 V to about 5.5 V, about 2 V to about 5 V, about 3 V to about 5 V, about 4.5 V to about 5 V, or about 5 V to about 6 V, as measured relative to a lithium metal anode. The batteries can be charged to the rated charge voltage while substantially retaining the performance characteristics specified above, such as in terms of coulombic efficiency, retention of specific capacity, retention of coulombic efficiency, and rate capability.

Thus, electrolyte formulations including certain combinations of the additives disclosed herein improve the cycle life in batteries with relatively high energy cathode and anode materials. Using electrolyte additives disclosed herein, improvement was demonstrated in full cells containing LiNi_{0.5}Mn_{1.5}O₄ (LMNO) cathodes and carbon based anodes, as shown in the specific example below.

The following examples describe specific aspects of some embodiments of the invention to illustrate and provide a description for those of ordinary skill in the art. The examples should not be construed as limiting the invention, as the examples merely provide specific methodology and testing useful in understanding and practicing some embodiments of the invention.

### Methods

Battery Cell Assembly. Battery cells were formed in a high purity argon filled glove box (M-Braun, O₂ and humidity content<0.1 ppm). A LiNi_{0.5}Mn_{1.5}O₄ (LMNO) cathode material and a graphite anode electrode were used. Each battery cell includes the composite cathode film, a polypropylene separator, and composite anode film. Electrolyte components were formulated and added to the battery cell.

Electrolyte Formulations. Electrolyte formulations include ethylene carbonate (EC) and ethyl methyl carbonate (EMC). Additives were formulated in EC/EMC (1:2 by volume) with 1M LiPF₆ at the stated weight percentages. All results are averages of three cells.

SEI Formation. Solid-electrolyte interphase (SEI) is formed during a formation cycle. For the cells tested herein, the formation cycle was 16 hours open current voltage (OCV) hold, followed by a C/20 charge to 4.9 V with a constant voltage (CV) hold for 0.5 hour, and then a C/3 discharge to 3.0 V. This formation cycle was repeated three times to complete formation.

Gas Generation Testing. Cells were heated to 50 degrees C. and charged to 4.9 V at 1 C with a CV hold for 180 hours. Gas generation was measured by use of a pressure transducer within the fixed volume cell. The measured change in pressure was converted to amount of gas generated (μmol) using the ideal gas law. The amount of gas was then converted to a rate by dividing by the time, and normalized to the area of the electrode. Thus, the final quantities are expressed as a rate of gas generation in units of μmol/hour/cm².

### Results

Electrolyte formulations containing the listed additives in LMNO cells resulted in up to 10 times less gas generation at long term, high temperature storage when stored in a fully charged state as compared to control electrolyte formulations. Further, the inventive additives and/or combination of additives did not have an appreciable negative effect of initial reversible capacity.

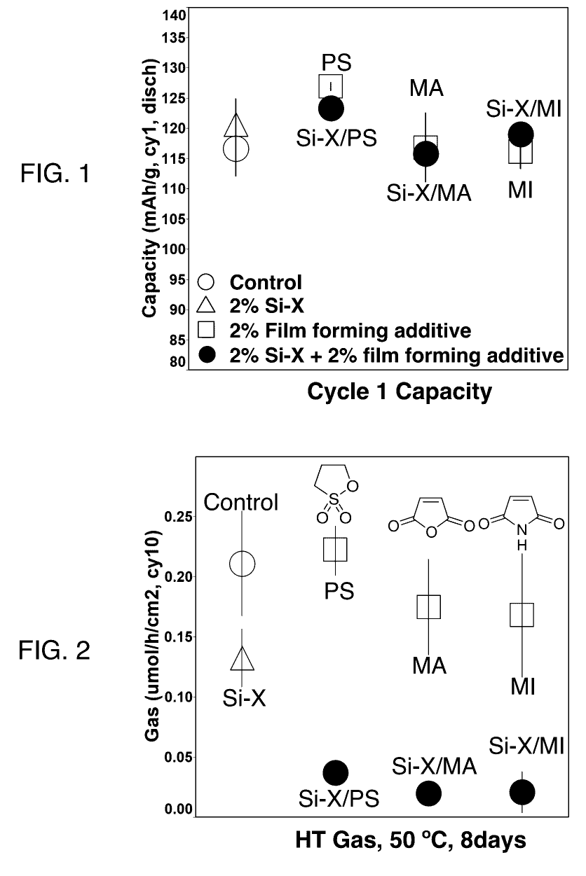

FIG. 1 illustrates the electrochemical performance of various electrolyte formulations, including some formulations made according to certain embodiments of the invention. FIG. 1 shows the capacity at the first cycle for several electrochemical cells, each containing a different electrolyte formulation. The data point shown for each electrolyte formulation is an average of the data collected from three batteries formed with the particular electrolyte formulation.

In FIG. 1, all electrolyte formulations contain a blend of organic solvents (EC:EMC 1:2 by volume) and a lithium salt (1 M LiPF₆). The base control electrolyte formulation was made without any additives and the battery containing this control electrolyte formulation had a first cycle discharge capacity of about 120 mAh/g. Another electrolyte control formulation was made by adding 2% by weight of a silicon containing additive to the base control electrolyte formulation. In this case, the silicon containing additive was tris(trimethylsilyl) phosphate. The tris(trimethylsilyl) phosphate containing electrolyte formulation also had a first cycle discharge capacity of about 120 mAh/g, making it statistically the same as the base control formulation.

Still referring to FIG. 1, electrolyte formulations containing film forming additives were tested. For example, 2% by weight of 1,3-propane sultone (PS), maleic anhydride (MA), and maleic imide (MI) were added to separate base control formualtions. The maleic anhydride formulation and the maleic imide formulation both had a first cycle discharge capacity of about 120 mAh/g, similar to the base control and the control with a silicon containing additive. The 1,3-propane sultone formulation had a first cycle discharge capacity apparently higher than the base control, although there was overlap in the first cycle discharge capacity performance with the control formulations.

Still referring to FIG. 1, electrolyte solutions were formulated according to certain embodiments of the invention to include both a silicon containing additive and a film forming additive. In each case, the electrolyte formulation included 2% by weight of a silicon containing additive (tris(trimethylsilyl)phosphate) and 2% by weight of a film forming additive. The combinations show in FIG. 1 are tris(trimethylsilyl) phosphate and 1,3-propane sultone; tris(trimethylsilyl)phosphate and maleic anhydride; and tris(trimethylsilyl)phosphate and maleic imide. Each of these combinations had a first cycle discharge capacity that was similar to the first cycle discharge capacity of the formulation that contained only the film forming additive.

In sum, the electrolyte formulations prepared according to embodiments disclosed herein performed similarly to the base control, the silicon containing electrolyte control, and the film forming additive formulations in a test of first cycle discharge capacity. The important result demonstrated by FIG. 1 is that no negative effect of initial discharge capacity was observed in any of the inventive electrolyte formulations as compared to the various control electrolyte formulations.

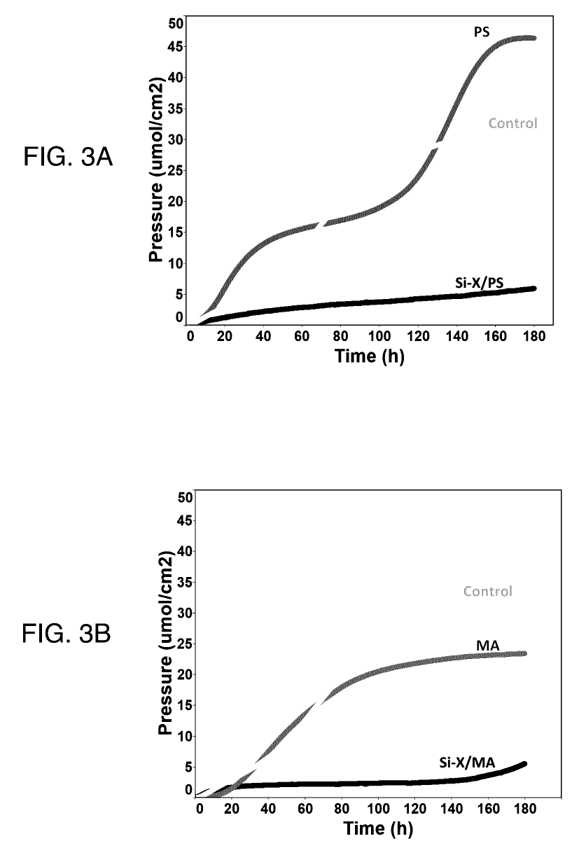

FIG. 2 illustrates the results of gas generation testing of the various electrolyte formulations from FIG. 1. The base control formulation, which did not contain any type of additive, generated from between about 0.16 μmol/hour/cm² of gas to about 0.26 μmol/hour/cm². The electrolyte formulation including a silicon containing additive generated less gas as compared to the base control formulation, generating from between about 0.11 μmol/hour/cm² of gas to about 0.15 μmol/hour/cm². The electrolyte formulation including 1,3-propane sultone generated from between about 0.20 μmol/hour/cm² of gas to about 0.24 μmol/hour/cm². The electrolyte formulation including maleic anhydride generated from between about 0.13 μmol/hour/cm² of gas to about 0.21 μmol/hour/cm². The electrolyte formulation including maleic imide generated from between about 0.12 μmol/hour/cm² of gas to about 0.23 μmol/hour/cm².

FIG. 2 illustrates that the electrolyte formulations including film forming additives performed comparably to the base control electrolyte formulation and the electrolyte formulation including a silicon containing additive. That is, none of the single-additive electrolyte formulations significantly improved the gas generation problem of the lithium ion batteries.

FIG. 2 also illustrates the reduction in gas generation in lithium ion cells that embodiments of the inventive electrolyte formulation can provide. The electrolyte formulations including tris(trimethylsilyl)phosphate and 1,3-propane sultone; tris(trimethylsilyl)phosphate and maleic anhydride; and tris(trimethylsilyl)phosphate and maleic imide each provided a significant reduction in gas generation. All three of these electrolyte formulations including the inventive combination of additives reduced the amount of gas generated to below about 0.05 μmol/hour/cm².

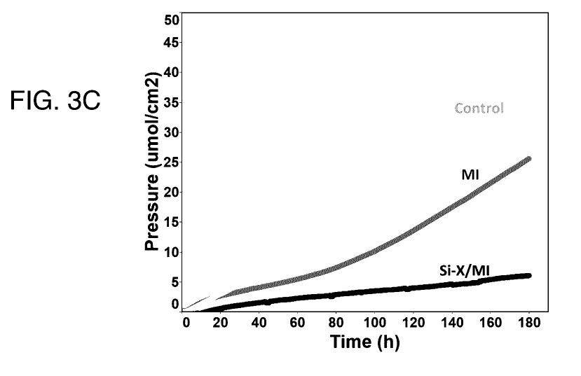

FIGS. 3A, 3B, and 3C illustrate the time-dependence of the gas evolution in battery cells formed with certain electrolyte formulations. FIG. 3A compares a base control electrolyte formulation and an electrolyte formulation including the film forming additive 1,3-propane sultone to an inventive electrolyte formulation that includes both the film forming additive 1,3-propane sultone and a silicon containing additive (in this case, tris(trimethylsilyl)phosphate). This embodiment of the inventive electrolyte formulation diverges quickly from the gas evolution traces of both the base control electrolyte formulation and the electrolyte formulation including the film forming additive 1,3-propane sultone.

Similarly, FIG. 3B compares a base control electrolyte formulation and an electrolyte formulation including the film forming additive 1,3-propane sultone to an inventive electrolyte formulation that includes both the film forming additive maleic anhydride and a silicon containing additive. As with the 1,3-propane sultone combination formulation, this embodiment of the inventive electrolyte formulation diverges quickly from the gas evolution traces of both the base control electrolyte formulation and the electrolyte formulation including the film forming additive maleic anhydride.

Still further, FIG. 3C compares a base control electrolyte formulation and an electrolyte formulation including the film forming additive maleic imide to an inventive electrolyte formulation that includes both the film forming additive maleic anhydride and a silicon containing additive. As with the 1,3-propane sultone combination formulation and the maleic anhydride formulation, this embodiment of the inventive electrolyte formulation diverges quickly from the gas evolution traces of both the base control electrolyte formulation and the electrolyte formulation including the film forming additive maleic imide.

The specific embodiments tested herein, and embodiments of the combination electrolyte formulations that share the inventive features disclosed herein, can significantly reduce the amount of gas generated in a lithium ion electrochemical cell tested at high temperature and/or at high voltages. Unexpectedly, the combination of a silicon containing additive and a film forming additive in a conventional electrolyte solution dramatically improves the gas generation performance of that conventional electrolyte without altering the first cycle discharge capacity. It is particularly unexpected because, individually, each of these additive types does not significantly reduce gas generation in a lithium ion battery stored at high temperature.

For example, the silicon containing additive tris(trimethylsilyl)phosphate somewhat reduced gas generation as seen in FIG. 2. However, the improvement in the reduction of gas generation for the inventive combination of additives is far more than would be expected by simply adding the contribution to reduction in gas generation by tris(trimethylsilyl)phosphate to the contribution to reduction in gas generation by the film forming additives. In other words, there appears to be a synergy in the inventive combination that is not accounted for by simply adding the expected gas generation reduction attributable to each type of additive.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, or process to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

1. A battery comprising:
an anode;
a cathode; and
an electrolyte formulation, comprising an additive combination consisting essentially of a silicon containing additive and a film forming heterocycle additive.

2. The battery of claim 1, wherein the silicon containing additive is represented by formula (I): 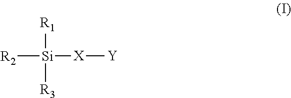
where R₁, R₂, and R₃ are independently selected from the group consisting of substituted and unsubstituted C₁-C₂₀ alkyl groups, substituted and unsubstituted C₁-C₂₀ alkenyl groups, substituted and unsubstituted C₁-C₂₀ alkynyl groups, and substituted and unsubstituted C₅-C₂₀ aryl groups; X is nitrogen or oxygen; and Y is selected from the group consisting of hydride groups, halo groups, hydroxy groups, thio groups, alkyl groups, alkenyl groups, alkynyl groups, aryl groups, iminyl groups, alkoxy groups, alkenoxy groups, alkynoxy groups, aryloxy groups, carboxy groups, alkylcarbonyloxy groups, alkenylcarbonyloxy groups, alkynylcarbonyloxy groups, arylcarbonyloxy groups, alkylthio groups, alkenylthio groups, alkynylthio groups, arylthio groups, cyano groups, N-substituted amino groups, alkylcarbonylamino groups, N-substituted alkylcarbonylamino groups, alkenylcarbonylamino groups, N-substituted alkenyl carbonylamino groups, alkynylcarbonyl amino groups, N-substituted alkynylcarbonylamino groups, arylcarbonylamino groups, and N-substituted arylcarbonylamino groups, boron-containing groups, aluminum-containing groups, silicon-containing groups, phosphorus-containing groups, and sulfur-containing groups.

3. The battery of claim 1, wherein the silicon containing additive comprises tris(trimethylsilyl)phosphate.

4. The battery of claim 3, wherein the film forming heterocycle additive comprises 1,3-propane sultone.

5. The battery of claim 2, wherein the film forming heterocycle additive comprises 1,3-propane sultone.

6. The battery of claim 1, wherein the film forming heterocycle additive comprises 1,3-propane sultone.

7. The battery of claim 3, wherein the film forming heterocycle additive comprises maleic anhydride.

8. The battery of claim 2, wherein the film forming heterocycle additive comprises maleic anhydride.

9. The battery of claim 1, wherein the film forming heterocycle additive comprises maleic anhydride.

10. The battery of claim 3, wherein the film forming heterocycle additive comprises maleic imide.

11. The battery of claim 2, wherein the film forming heterocycle additive comprises maleic imide.

12. The battery of claim 1, wherein the film forming heterocycle additive comprises maleic imide.

13. The battery of claim 1, wherein the cathode comprises LiNi_{0.5}Mn_{1.5}O₄.

14. A method of making a battery, comprising:
assembling an anode, a cathode, and an electrolyte formulation including an additive combination consisting essentially of a silicon containing additive and a film forming heterocycle additive.

15. The method of claim 14, wherein the silicon containing additive is represented by formula (I): 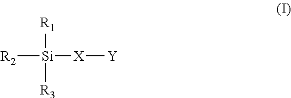
where R₁, R₂, and R₃ are independently selected from the group consisting of substituted and unsubstituted C₁-C₂₀ alkyl groups, substituted and unsubstituted C₁-C₂₀ alkenyl groups, substituted and unsubstituted C₁-C₂₀ alkynyl groups, and substituted and unsubstituted C₅-C₂₀ aryl groups; X is nitrogen or oxygen; and Y is selected from the group consisting of hydride groups, halo groups, hydroxy groups, thio groups, alkyl groups, alkenyl groups, alkynyl groups, aryl groups, iminyl groups, alkoxy groups, alkenoxy groups, alkynoxy groups, aryloxy groups, carboxy groups, alkylcarbonyloxy groups, alkenylcarbonyloxy groups, alkynylcarbonyloxy groups, arylcarbonyloxy groups, alkylthio groups, alkenylthio groups, alkynylthio groups, arylthio groups, cyano groups, N-substituted amino groups, alkylcarbonylamino groups, N-substituted alkylcarbonylamino groups, alkenylcarbonylamino groups, N-substituted alkenyl carbonylamino groups, alkynylcarbonyl amino groups, N-substituted alkynylcarbonylamino groups, arylcarbonylamino groups, and N-substituted arylcarbonylamino groups, boron-containing groups, aluminum-containing groups, silicon-containing groups, phosphorus-containing groups, and sulfur-containing groups.

16. The method of claim 14, wherein the silicon containing additive comprises tris(trimethylsilyl)phosphate.

17. The method of claim 16, wherein film forming heterocycle additive comprises one or more of 1,3-propane sultone, maleic anhydride, and maleic imide.

18. The method of claim 15, wherein film forming heterocycle additive comprises one or more of 1,3-propane sultone, maleic anhydride, and maleic imide.

19. The method of claim 14, wherein film forming heterocycle additive comprises one or more of 1,3-propane sultone, maleic anhydride, and maleic imide.

20. The method of claim 14, wherein the cathode comprises LiNi_{0.5}Mn_{1.5}O₄.
